(19) United States
(12) Patent Application Publication
(10) Pub. No.: US 2025/0233889 A1
(43) Pub. Date: Jul. 17, 2025

(54) RISK ANALYSIS AND MITIGATION USING ENTERPRISE GROUP MEMBERSHIP

(71) Applicant: Comcast Cable Communications, LLC, Philadelphia, PA (US)

(72) Inventors: Sergey MIRONENKO, Ellicott City, MD (US); Zhenqin GE, Norristown, PA (US); Meishan CHENG, San Diego, CA (US)

(21) Appl. No.: 18/414,511

(22) Filed: Jan. 17, 2024

(51) Int. Cl. H04L 9/40

(52) U.S. Cl. CPC H04L 63/20; H04L 63/1433

(57) ABSTRACT

Systems and methods are disclosed for technical user classification using group membership. User accounts with a more enterprise-related responsibilities may pose a higher risk of being targeted by a malicious external attacker. Classifying users based on enterprise groups associated with more enterprise-related responsibilities may allow more selective application of resource-expensive security solutions for high-risk users.

### BACKGROUND

Large enterprises spend too much time and resources micromanaging cybersecurity issues for each of its users, from risk analysis to mitigation. For example, conventional enterprise cybersecurity systems may flag certain user actions, but the results may contain a large number of false positives. Additionally, conventional systems may impose risk mitigations measures but do so indiscriminately, resulting in inefficiencies. Therefore, new techniques for cybersecurity risk analysis and mitigation are needed.

### SUMMARY

Systems and methods are disclosed for risk analysis and mitigation in an enterprise network. An example system may classify users into two groups, such as technical users and non-technical users, based on enterprise-related responsibilities. For example, technical users may be members of a system administration group within the enterprise and therefore have additional responsibilities such as access rights that non-technical users, such as a secretary, would not have. The system may adjust the security data or protections associated with select users based on their classification. Similarly, a system may improve the efficiency of risk analysis by filtering traditional security alerts for select users based on their classification. For example, filtering a security alert may include ignoring, filtering from a report, or determining not to provide an alert.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system.

FIG. 2 shows an example graph of a classification algorithm.

FIG. 3 shows an example chart of technical group membership values.

FIG. 4 shows an example chart of non-technical group membership values.

FIG. 5 shows an example chart of the group membership values of a user.

FIG. 6 shows an example method.

FIG. 7 shows an example method.

FIG. 8 shows an example method.

FIG. 9 shows an example architecture.

### DETAILED DESCRIPTION OF ILLUSTRATIVE EMBODIMENTS

In an enterprise system, user accounts with a more enterprise-related responsibilities may pose a higher risk of being targeted by a malicious external attacker. The present techniques allow for more selective application of resource-expensive security solutions, such as additional authentication measures, monitoring the activity of a user account, or other additional security data and/or protections. Classifying users based on enterprise groups associated with more enterprise-related responsibilities may allow the enterprise to selectively implement these additional solutions for only these higher-risk user accounts.

For example, an enterprise system may receive a plurality of requests to access a service associated with an enterprise. The requests may be received by a computing device, server, and/or service in the enterprise, such as an authentication service. The authentication service may be part of the enterprise system. The authentication service may use a model to classify user accounts according to the enterprise-related responsibilities associated with group membership data for the user accounts. The group membership data of the user account may indicate a plurality of groups of the enterprise associated with the user accounts. The model may be a machine learning model that comprises one or more of a support vector machine, a binary classifier, or a model configured to classify user accounts based on enterprise-related responsibilities associated with the user account.

Enterprise groups may be assigned on an enterprise level using a service configured to manage associations between user accounts and the enterprise groups. The service may input the determined group membership data into the model (e.g., or other model). The model may be trained to classify the user account according to the enterprise-related responsibilities associated with the user account. For example, the machine learning model may determine if the user account of the user device is classified as technical or a non-technical based on the technical responsibilities, as indicated by a plurality of groups of the enterprise associated with the user account. The service may determine training data associated with a plurality of user accounts in the enterprise. The machine learning model may be trained, based on this training data, to classify user accounts based on corresponding enterprise groups of the enterprise, associated with the respective user accounts. The training data may comprise, for each user account, an indication of a classification (e.g., technical, non-technical) of the user account and an indication of which enterprise groups the user account is associated with. The machine-learning model may provide users with information such as the values each group contributes to the determination of the classification scores.

It should be noted that the terms technical and non-technical are used as example labels for a classification, but other classifications or classification labels may be used according to the specific needs of a particular application. It should be appreciated that in a large enterprise, the enterprise may have hundreds of thousands of groups or more and a single user account within the enterprise may be associated with hundreds or even thousands of those groups. Determining whether a user account is classified as technical or non-technical may be based on a complex pattern of memberships that may not be readily ascertainable without machine learning techniques. As a simple explanation, a user that is a member of the system administration group may be classified as technical according to more enterprise-related responsibilities, and a user that is a member of the business licensing group may be classified as non-technical, according to less enterprise-related responsibilities. Enterprise-related responsibilities may be associated with the permissions a user account has. For example, a user account might have access to certain features, applications, sensitive information, or any combination thereof that may indicate the user account is of higher risk to be targeted. More enterprise-related responsibilities associated with a user account might indicate that the user account is of higher risk to be targeted. Classifying user accounts according to the enterprise-related responsibilities of the user account may help manage such risk.

The classification of the user account may be based on a quantity of groups of the plurality of groups of the enterprise associated with that user account. The classification of the user account may be based on a type of groups of the plurality of groups of the enterprise associated with that user account. The classification of the user account may be based on a quantity of permissions associated with the enterprise-related responsibilities of the user account. The classification of the user account may be based on a type of permission associated with the enterprise-related responsibilities of the user account. However, if an employee is both in the business licensing group and belongs to several groups related to more enterprise-related responsibilities, simple rules may not be sufficient to determine a classification. In other scenarios, a simple model with a set of prioritized rules, or even simpler rules may be appropriate depending on the complexity of the enterprise. If the user associated with the user device is determined to be classified as a technical user, then events associated with that user device may be treated differently or additional mitigation measures may be imposed. The data may be classified by the machine learning model based on one or more of a scheduled process, a process triggered by a condition, or based on a request from a user account to access a service.

The plurality of requests may be processed, based on data classified using the machine learning model. A first portion of the requests to access the service associated with the enterprise may be associated with a user account having a first classification. A second portion of the requests to access the service associated with the enterprise may be associated with a user account having a second classification. User accounts having a first classification may be associated with a first level of security data and/or protections. User accounts having a second classification may be associated with a second level of security data and/or protections. The first classification may be non-technical or another classification that indicates the need for less security data and/or protections. The second classification may be technical or another classification that indicates the need for more security data and/or protections. The first level of security data and/or protections may comprise the system requesting a first credential of the user account. The first credential may be a username and password, username and pin, or any combination thereof. The second level of security data and/or protections may comprise the system requesting the first credential of the user account and a second credential of the user account. The second credential of the user account may comprise a code, biometric, or other credential commonly used in two-factor authentication.

Furthermore, technical user accounts often perform activity that a non-technical user account would not, such as running PowerShell, using command line executable, mounting a drive, checking out code, and/or the like. This can be leveraged by enterprise cybersecurity systems that implement the classification technique described herein. The processing of an event may be based on the classification of the user account. For example, when a user account associated with less enterprise-related responsibilities, such as non-technical user account, attempts to run a discovery command, a computing device, server, and/or service, such as a detection service, may detect a cybersecurity event (e.g., running the discovery command) associated with the user activity of a user account associated with the enterprise. On the other hand, when a user account associated with more enterprise-related responsibilities, such as a technical user, attempts to run a discovery command, the detection service or other service in the enterprise system may process the event. Processing the event may comprise increasing the security data and/or protections associated with the user account accessing one or more services. Processing the event may comprise filtering the event for a service, such as a security service of the enterprise system. Processing the event may comprise generating an indication of potential threat for the security service. Processing the event may comprise allowing the user account to continue the activity associated with the event (e.g., running a command, such as the discovery command). Processing the event may comprise ignoring the event. Processing the event may comprise sending an alert to the security service.

In some scenarios, a classification process may be periodically performed to generate classifications of users, which may be stored in a database. The classification process may be executed in response to a specific request triggered by the event. The enterprise groups may be assigned on an enterprise level using a service configured to manage associations between user accounts and enterprise groups. Once the classification is determined, the event may be processed.

Classifying a user as technical or non-technical may have other applications not disclosed herein. For example, if a user classified as non-technical ran administrative command, logged on to a server (e.g., database, webserver, etc.) the enterprise system may flag that activity as suspicious. If a non-technical user ran a discovery commands (e.g., whoami, route, etc.), the enterprise system may flag that the user is potentially compromised. Furthermore, the application of technical and non-technical filtering may help threat hunting on anomalous behavior for account discovery against Activity Directory, may help be a reference data point to help determine if a local administrative right should be granted, or may help SIEM/SOAR system integration. Disclosed herein are systems and methods for technical user classification using group membership.

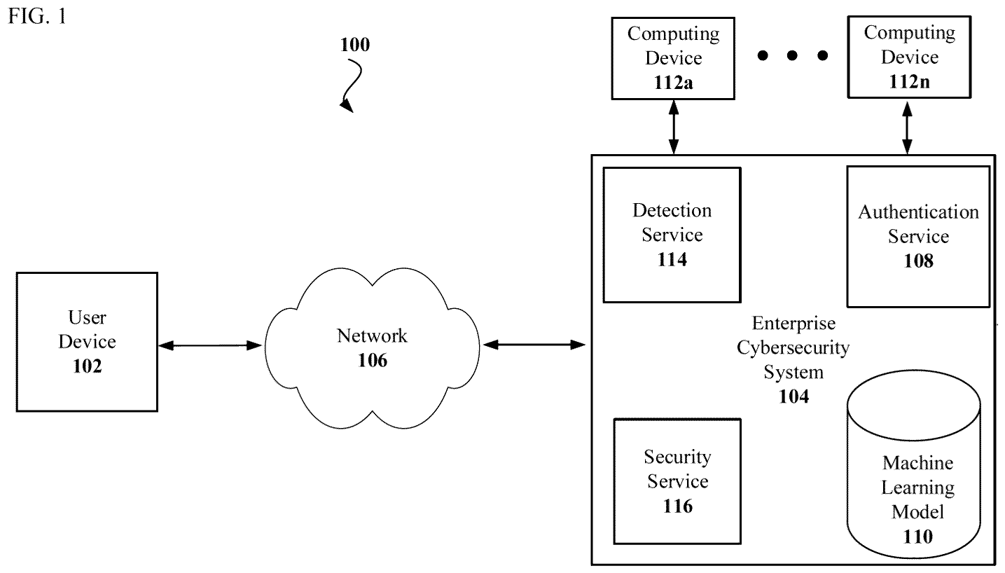

FIG. 1 shows an example system 100. The system 100 may comprise a user device 102. User device 102 may generally include any device now known to those having ordinary skill in the art or developed in the future that is capable of being used in an enterprise system. Non-limiting examples of user devices may include televisions, smart televisions, laptops, personal digital assistants (PDAs), tablet computing devices, smartphones, personal computers (PCs), display monitors or terminals, radios, audio devices, speakers, headphones, haptic devices, electronic reading devices (“e-readers”), light emitting diode (LED) devices, organic LED (OLED) devices, wearable screens, set-top-boxes, satellite receivers, video-on-demand (VOD) receivers, content receivers, digital video recorders (DVRs), personal video recorders (PVRs), hard drives, flash drives, storage servers, digital video disc (DVD) devices, or the like. A user, recipient, viewer, audience member, or the like may generally include an individual viewing, consuming, recording, streaming, or otherwise interacting with a content asset using a content presentation device.

The user device 102 may be configured to communicate with a network, such as network 106. Network 106 may be an enterprise security network. An enterprise security network may be an internal and/or external network that is part of an enterprise cybersecurity system, such as enterprise cybersecurity system 104. The enterprise cybersecurity system may control the traffic within the network and/or control traffic in an out of the enterprise security network. The user device 102 may communicate with the network 106 via any of a variety of communications mediums, such as a coaxial cable network, a fiber-optic cable network, a hybrid fiber-coaxial (HFC) network, a satellite transmission channel, a television broadcast network, a cable television network, a satellite television network, an internet service provider (ISP), a computing device advertising network, a media distribution network, a cloud computing network, a local area network (LAN), a wide area network (WAN), a terrestrial network, a mobile network, and/or any combination thereof. When part of a cable television system, the network 106 may comprise a cable modem termination system (CMTS).

The network 106 may provide various services to user devices, such as the user device 102, and may include the appropriate infrastructure for these services. For example, the network 106 may include one or more network routers (not shown). The network routers may comprise one or more edge routers, which may provide connectivity to other networks, including the Internet, a telephone network, or the like.

The network 106 may provide user devices, such as the user device 102, with access to a service associated with an enterprise security system, such as enterprise security system 104, which may comprise one or more services (e.g., or servers, computing entities, nodes, resources, networks, access points), such as authentication service 108, a machine learning model 110, an detection service 114, and a security service 116. The enterprise cybersecurity system 104 may be configured to provide enterprise cybersecurity systems to a user device, such as the user device 102. The services provided by the enterprise cybersecurity system 104 may be internal services provided by a single server or computing entity, or in any combination of the server(s) listed above.

The machine learning model 110 may be trained on based on group memberships associated user accounts of an enterprise. Thus, the machine learning model 110 may be separately trained for each enterprise that implements the machine learning model 110. Groups within an enterprise system may comprise the various internal organizations, departments, committees, etc. that make up the enterprise. An enterprise may have hundreds of thousands of groups, or more. The initial training data for the machine learning model 110 may be manually tagged. The groups may be stored in an enterprise group management database. The groups may be managed by a service (e.g., or computing device, computing entity, and/or server), such as directory service, a role management service, an identity management service, and/or the like. Each user account of the enterprise may be associated with one or more enterprise groups. Enterprise groups may be classified according to enterprise-related responsibilities associated with group membership of the user accounts, such as technical responsibilities. The enterprise-related responsibilities associated with the group membership of the user accounts may be based on a quantity of groups of the plurality of groups of the enterprise associated with that user account. The enterprise-related responsibilities associated with the group membership of the user accounts may be based on a type of groups of the plurality of groups of the enterprise associated with that user account. The enterprise-related responsibilities associated with the group membership of the user accounts may be based on a quantity of permissions associated with one or more groups of the plurality of groups of the enterprise associated with that user account. The enterprise-related responsibilities associated with the group membership of the user accounts may be based on a type of permission associated with one or more groups of the plurality of groups of the enterprise associated with that user account.

Enterprise groups may be user-defined groups defined by the enterprise using a group management user interface. Enterprise groups may be different than and/or managed separately than conventional permission level groups built into an operating system or network device. Enterprise groups may have associated email lists.

The machine learning model 110 may be retrained periodically based on the initial data set, new groups, and new users. The machine learning model 110 may be configured to analyze each user and each group membership of each user to determine the smallest number of data points (e.g., combination of groups) may be indicative of a user being technical or non-technical. For each user, the machine learning model 110 may generate a binary vector for each user, where the value of 1 may indicate the group that the user has membership in and value of 0 may be used to indicate each group the user does not have membership in. The machine learning model may also convert the binary vector into a sparse vector format to keep only the most relative groups. For example, the total number of groups in the enterprise may be over 90,000 (e.g., groups used to determine certain access privileges). The size of the set of vectors related to the security groups of a user may be reduced over 99.9% to only the most relative groups. The list of relative groups may change based on retraining the machine learning model 110. The machine learning model 110 may comprise filters configured to associate patterns of group memberships with corresponding risk groups. There may be only two risk groups (e.g., technical vs non-technical, high risk vs low risk), or there may be a plurality of groups (e.g., high risk). The machine learning model 110 may be configured to receive request for a classification of a user associated with a user device, such as user device 102. The machine learning model 110 may be configured to send the classification of a user associated with the user device.

The authentication service 108 may be configured to receive, from a user device, a request to access a service associated with an enterprise or computing device associated with an enterprise, such as computing device 112a-112n. The request may comprise a variety of different data, such as, but not limited, credentials of the user associated with the user device, and group memberships within the enterprise associated with the user. The authentication service 108 may be configured to request additional credentials from the user device 102 based on the classification of the user associated with the user device 102. The authentication service 108 may be configured to communicated with the machine learning model 110 to determine the classification of the user associated with the user device 102. The authentication service 108 may be configured to grant access to one or more computing devices to the user device 102 based on authenticating the received credentials.

The detection service 114 may be configured to receive one or more alerts in response to a cybersecurity incident or event associated with activity of a user device, such as user device 102, or any other computing device. The security service 116 may be configured to monitor for cybersecurity incidents or events related to the enterprise cybersecurity system 104 and send alerts in response to such incidents or events to the detection service 114. The detection service 114 may be configured to request from the machine learning model 110 the classification of the user associated with the user device 102 associated with the event. The incident response 114 may be configured to determine the classification of the event. The event classification may be technical or non-technical. For example, a technical event may be the user device 102 running a discovery command. An example of a non-technical event may be the user device 102 interacting with a phishing email. The detection service 114 may be configured to compare the classification of the user associated with the user device 102 with a classification of the event. The detection service 114 may be configured to ignore the alert if the classification associated with the event matches the classification of the user or if the classification associated with the event is non-technical and the classification of the user is technical. The detection service 114 may be configured to send an escalated alert to the security service 116 based on the classification associated with the event being technical and the classification of the user being non-technical. The detection service 114 may continue to monitor for additional alerts and events after ignoring an alert or after escalating an alert.

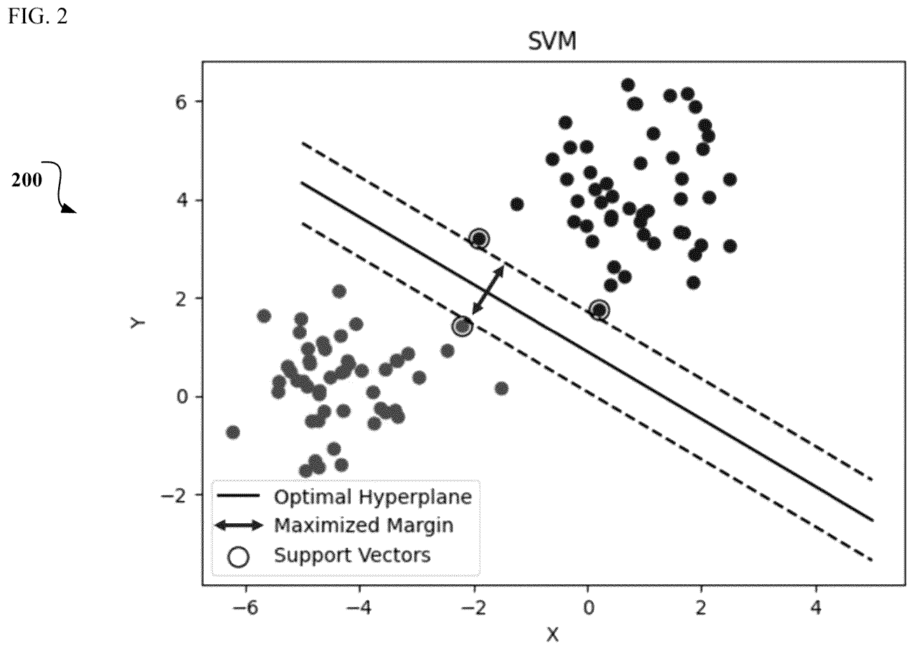

FIG. 2 shows an example graph 200 of a classification algorithm that may be used by the machine learning model 110 in FIG. 1. The machine learning model may be configured to use Support Vector Machine (SVM) algorithms, logistic regression, random forest, XG boost, or any other compatible algorithm. The graph 200 may show an example mapping of the vectors of each group within the enterprise. The three circles on the dotted lines represent the support vectors of the two different classifications, non-technical groups (support vectors below the optimal hyperplane) and technical groups (support vectors above the optimal hyperplane). The maximized margin, denoted by the solid line with two arrows on each end, may divide the group of squares and circles points, such that the distance between the support vectors for either group is maximized. The optimal hyperplane, denoted by the solid line in the middle of the graph, may be a line parallel and equidistant to the dotted lines created by the support vectors.

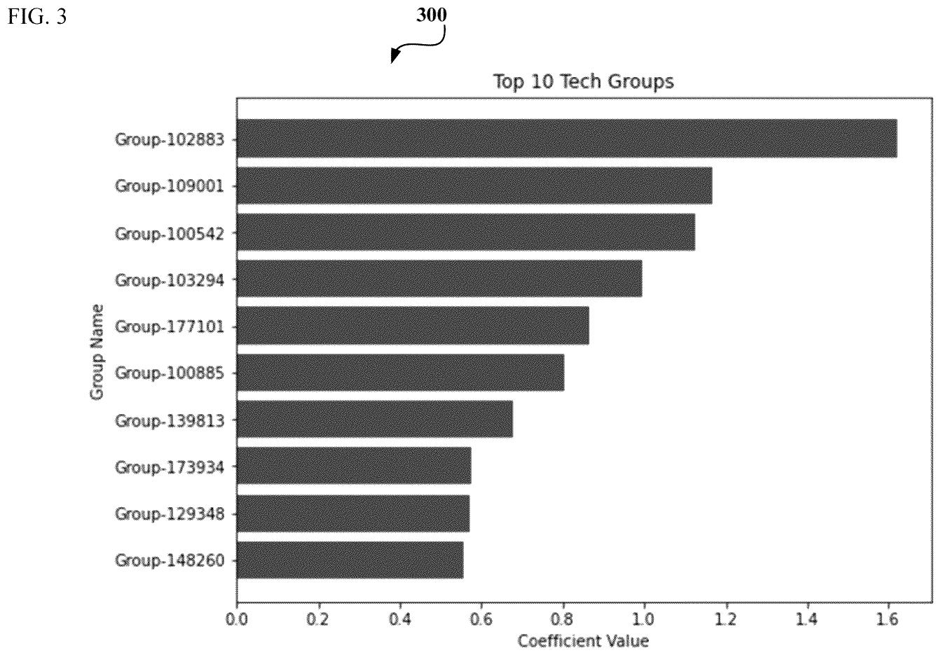

FIG. 3 shows an example chart 300 of group membership values of the top technical groups in an enterprise. Chart 300 is an example meant to visualize the internal weights and importance, such as the coefficient values in the x-axis, of specific groups in an enterprise. Group membership to some groups will be more indicative of the user being a technical user or more indicative of the user being a non-technical user. The higher the coefficient value, the more likelihood that group membership to that group may indicate that the user should be classified as technical, or that the user has more enterprise-related responsibilities. For example, chart 300 may show the top ten technical indicative groups in an enterprise. Group 102883 is an example a group with an extremely high coefficient value in the enterprise. Thus, if a user was a member of that example group, there would be a higher indication that the user should be classified as a technical user. However, membership to a single group, even to Group 102883, whose membership is highly indicative of the user being technical, may not be dispositive that the ultimate classification of the user will match the indication of the single group. The combined weight of all the groups a user has membership to may be used to determine the classification results.

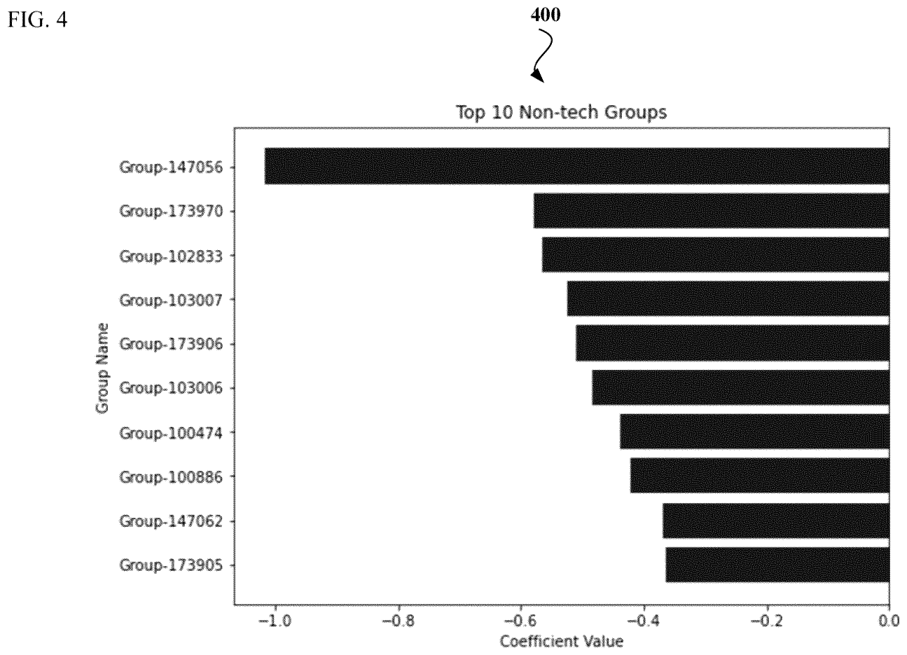

FIG. 4 shows an example chart 400 of group membership values of the top non-technical groups in an enterprise. Chart 400 is an example meant to visualize the internal weights and importance, such as the coefficient values in the x-axis, of specific groups in an enterprise. Group membership to some groups will be more indicative of the user being a technical user or more indicative of the user being a non-technical user, or that the user has less enterprise-related responsibilities. The lower the coefficient value, the more likelihood that group membership to that group may indicate that the user should be classified as non-technical. For example, chart 400 may show the top ten non-technical indicative groups in an enterprise. Group 147056 is an example a group with an extremely low coefficient value in the enterprise. Thus, if a user was a member of that example group, there would be a higher indication that the user should be classified as a non-technical user. However, membership to a single group, even to Group 147056, whose membership is highly indicative of the user being non-technical, may not be dispositive that the ultimate classification of the user will match the indication of the single group. The combined weight of all the groups a user has membership to may be used to determine the classification results.

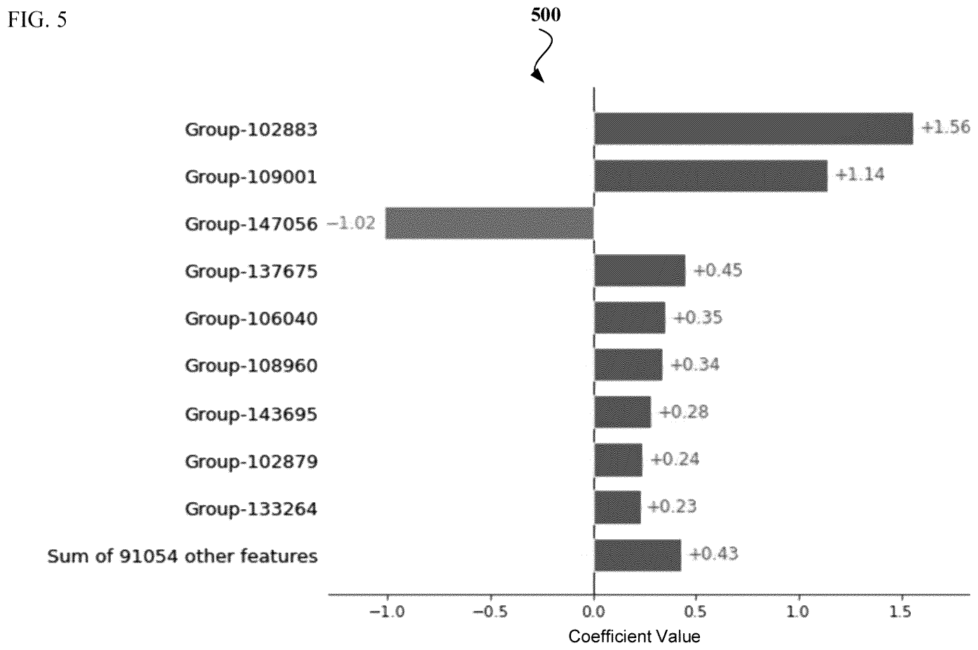

FIG. 5 shows an example chart 500 of the coefficient values of groups a specific user has membership to. Chart 500 is an example meant to visualize the internal weights and importance, such as the coefficient values in the x-axis, of specific groups in an enterprise that a specific user has membership to. In this example, the example user may have group membership to each of the example groups, Group 102883, 109001, 147056, 137675, 106040, 108960, 143695, 102879, 133264, as well as the 91,054 other groups, the sum of which is included at the bottom of the chart. The combined weight of all the groups a user has membership to may be used to determine the classification results, such as calculating the sum of each coefficient value of each group the user has membership to. Although the user may be a member of Group 147056, which may indicate a high likelihood of the user being non-technical, the user is also a member of over 90,000 other groups. Therefore, the true indication of whether the user is technical or non-technical may be based on the sum of the coefficient values of each group the user has membership to. In this example, the sum of the coefficient values of each group may indicate that the user is a technical user. However, it is understood that this example is not meant to be limiting.

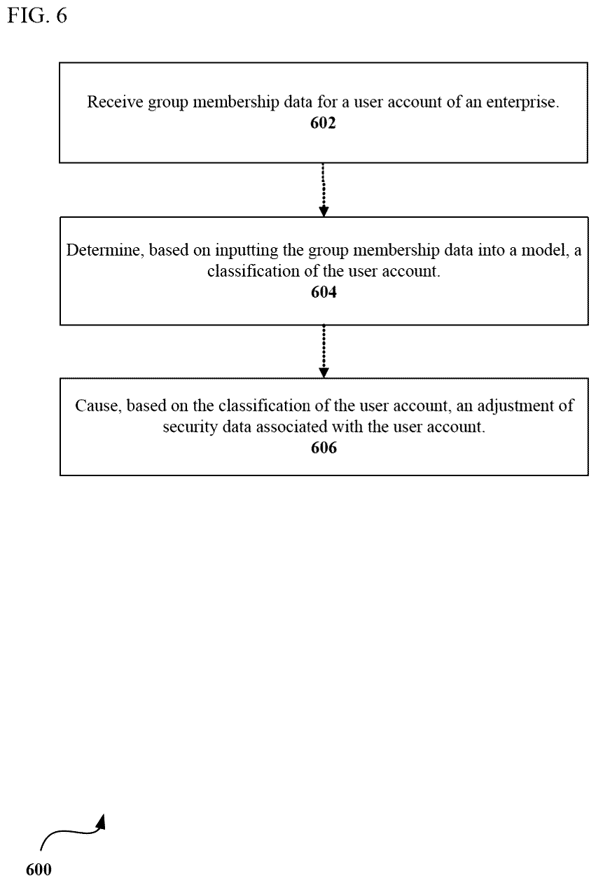

FIG. 6 shows an example method 600. The method 600 may be employed in the system illustrated in FIG. 1. The method 600 may be performed by an enterprise cybersecurity system, such as enterprise cybersecurity system 104 in FIG. 1, or any such part of or combination of entities within the enterprise cybersecurity system 104.

In step 602, group membership data for a user account of an enterprise may be received. The group membership data may indicate at least a plurality of groups of the enterprise associated with the user account. The user account of the enterprise may be associated with an employee of the enterprise. The user account may be associated with a user device, such as user device 102 in FIG. 1. The groups of the enterprise may be assigned on an enterprise level using a service configured to manage associations between user accounts and enterprise groups. The group membership data may be received by a service, such as the security service 116 in FIG. 1, or any other service associated with the enterprise. An enterprise may comprise a business, organization company, or any other entity.

In step 604, a classification of the user may be determined based on inputting the group membership data into a model. The model may be a machine learning model, such as machine learning model 110 in FIG. 1. The machine learning model may be trained to classify user accounts according to an enterprise-related responsibilities associated with group membership for the user accounts. The machine learning model may comprise one or more of a support vector machine, a binary classifier, or a model configured to classify user accounts based on the enterprise-related responsibilities. The classification of the user account may be based on a quantity of groups of the plurality of groups of the enterprise associated with that user account. The classification of the user account may be based on a type of groups of the plurality of groups of the enterprise associated with that user account. The classification of the user account may be based on a quantity of permissions associated with the enterprise-related responsibilities of the user account. The classification of the user account may be based on a type of permission associated with the enterprise-related responsibilities of the user account. The machine learning model may be updated based on updates in associations of enterprise groups with corresponding user accounts.

In step 606, an adjustment of the security data and/or protections associated with the user account may be caused. The adjustment may be caused based on the classification of the user account. The adjustment of the security data and/or protections associated with the user account may comprise adding an authentication process to the user account. The adjustment of the security data and/or protections associated with the user account may comprise monitoring the activity of the user account. The adjustment of the security data and/or protections associated with the user account may be based on a threshold level of security data and/or protections necessary for the classification associated with the user account. An indication of the adjustment of the security data and/or protections associated with the user account may be sent to the security service 116 or any other service associated with the enterprise.

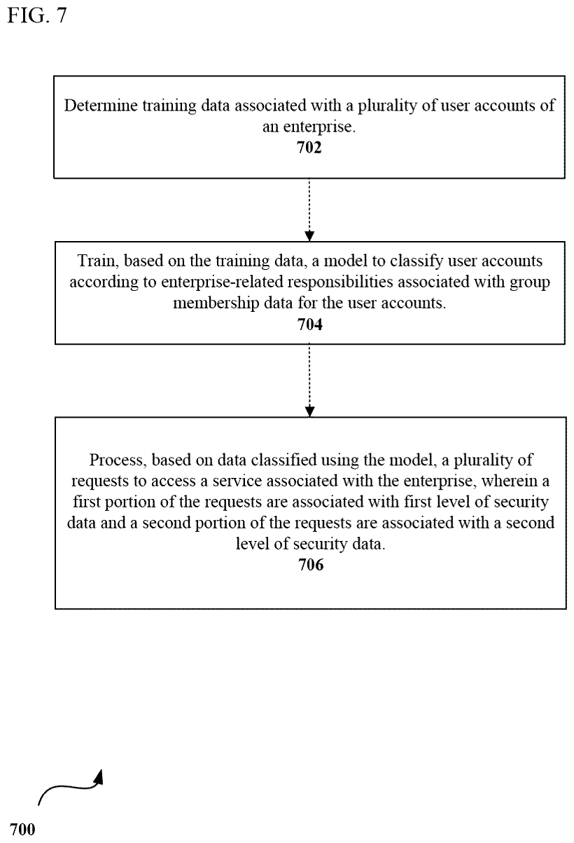

FIG. 7 shows an example method 700. The method 700 may be employed in the system illustrated in FIG. 1. The method 700 may be performed by an enterprise cybersecurity system, such as enterprise cybersecurity system 104 in FIG. 1, or any such part of or combination of entities within the enterprise cybersecurity system 104.

In step 702, training data associated with a plurality of user accounts of an enterprise may be determined. The training data may comprise, for each user account of the plurality of user accounts, an indication of a classification of the user account and an indication of which enterprise groups the user account is associated with. The user account of the enterprise may be associated with an employee of the enterprise. The user accounts may be associated with a user device, such as user device 102 in FIG. 1. The determination may be made by a service such as the authentication service 108 in FIG. 1, or any other service associated with the enterprise. An enterprise may comprise a business, organization company, or any other entity.

In step 704, a model may be trained to classify user accounts according to enterprise-related responsibilities associated with group membership data for the user accounts based on the training data in step 702. The model may be a machine learning model, such as the machine learning model 110 in FIG. 1. The machine learning model may comprise one or more of a support vector machine, a binary classifier, or a model configured to classify users as technical or non-technical. The enterprise groups may be assigned on an enterprise level using a service, such as security service 116 in FIG. 1, configured to manage associations between user accounts and enterprise groups. The data may be classified by the machine learning model based on one or more of a scheduled process, a process triggered by conditions, or based on the request of the plurality of requests to access the service. The classification of the user account may be based on a quantity of groups of the plurality of groups of the enterprise associated with that user account. The classification of the user account may be based on a type of groups of the plurality of groups of the enterprise associated with that user account. The classification of the user account may be based on a quantity of permissions associated with the enterprise-related responsibilities of the user account. The classification of the user account may be based on a type of permission associated with the enterprise-related responsibilities of the user account. The machine learning model may be updated based on updates in associations of enterprise groups with corresponding user accounts.

In step 706, a plurality of requests to access a service associated with the enterprise may be processed. The plurality of requests may be processed based on the data classified by the model. A first portion of the requests having a first classification may be associated with a first level of security data and/or protections related to accessing the service. A second portion of the requests having a second classification may be associated with a second level of security data and/or protections related to accessing the service. User accounts having a first classification may be associated with a first level of security data and/or protections. User accounts having a second classification may be associated with a second level of security data and/or protections. The first classification may be non-technical or another classification that indicates the need for less security data and/or protections. The second classification may be technical or another classification that indicates the need for more security data and/or protections. The first level of security data and/or protections may comprise the system requesting a first credential of the user account. The first credential may be a username and password, username and pin, or any combination thereof. The second level of security data and/or protections may comprise the system requesting the first credential of the user account and a second credential of the user account. The second credential of the user account may comprise a code, biometric, or other credential commonly used in two-factor authentication.

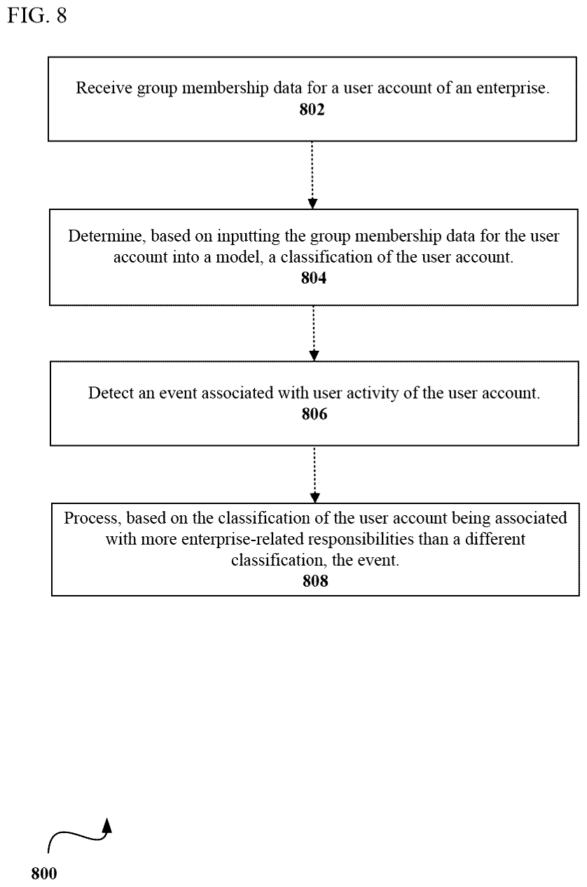

FIG. 8 shows an example method 800. The method 800 may be employed in the system illustrated in FIG. 1. The method 800 may be performed by an enterprise cybersecurity system, such as enterprise cybersecurity system 104 in FIG. 1, or any such part of or combination of entities within the enterprise cybersecurity system 104.

In step 802, group membership data for a user account of an enterprise may be received. The group membership data may indicate at least a plurality of groups of the enterprise associated with the user account. The user account of the enterprise may be associated with an employee of the enterprise. The user account may be associated with a user device, such as user device 102 in FIG. 1. The groups of the enterprise may be assigned on an enterprise level using a service configured to manage associations between user accounts and enterprise groups. The group membership data may be received by a service, such as the security service 116 in FIG. 1, or any other service associated with the enterprise. An enterprise may comprise a business, organization company, or any other entity.

In step 804, a classification of the user may be determined based on inputting the group membership data into a model. The model may be a machine learning model, such as machine learning model 110 in FIG. 1. The machine learning model may be trained to classify user accounts according to an enterprise-related responsibilities associated with group membership for the user accounts. The machine learning model may comprise one or more of a support vector machine, a binary classifier, or a model configured to classify user accounts based on the enterprise-related responsibilities. The classification of the user account may be based on a quantity of groups of the plurality of groups of the enterprise associated with that user account. The classification of the user account may be based on a type of groups of the plurality of groups of the enterprise associated with that user account. The classification of the user account may be based on a quantity of permissions associated with the enterprise-related responsibilities of the user account. The classification of the user account may be based on a type of permission associated with the enterprise-related responsibilities of the user account. The machine learning model may be updated based on updates in associations of enterprise groups with corresponding user accounts.

At step 806, an event associated with user activity of a user account associated with an enterprise may be detected. The event may be detected by a service, such as detection service 114 in FIG. 1, or any other service associated with the enterprise. An event may be any cybersecurity incident the enterprise cybersecurity system, such as cybersecurity system 104 in FIG. 1, would want to monitor or flag, such as a user running discovery commands. A security service, such as security service 116 in FIG. 1, may be monitoring each enterprise user for suspicious events. The security service may send an alert to the detection service based on a monitored event.

In step 808, the event may be processed based on the classification of the user account. Processing the event may comprise increasing the security data and/or protections associated with the user account accessing one or more services. Processing the event may comprise filtering the event for a service, such a security service of the enterprise system. Processing the event may comprise generating an indication of potential threat for the security service. Processing the event may comprise allowing the user account to continue the user activity that caused the event. Processing the event may comprise ignoring the event. Processing the event may comprise sending an alert to the security service.

The detection service (e.g., or other server, service, and/or computing device) may continue to monitor for additional events. The detection service may receive a second event associated with a second user account associated with a second user device in the enterprise. The detection service may request the classification of the second user from the model. The model may determine the classification of the second user and send the classification to the detection service. The detection service may determine the second event cannot be ignored based on comparing a classification associated with the second event and the classification of the second user account. The determination that the second event cannot be ignored may be based on determining the classification associated with the second event is technical and the classification of the second user account is non-technical. The detection service may send an alert to the security service based on the determining this classification and that the second alert cannot be ignored. The detection service may continue to monitor for additional events.

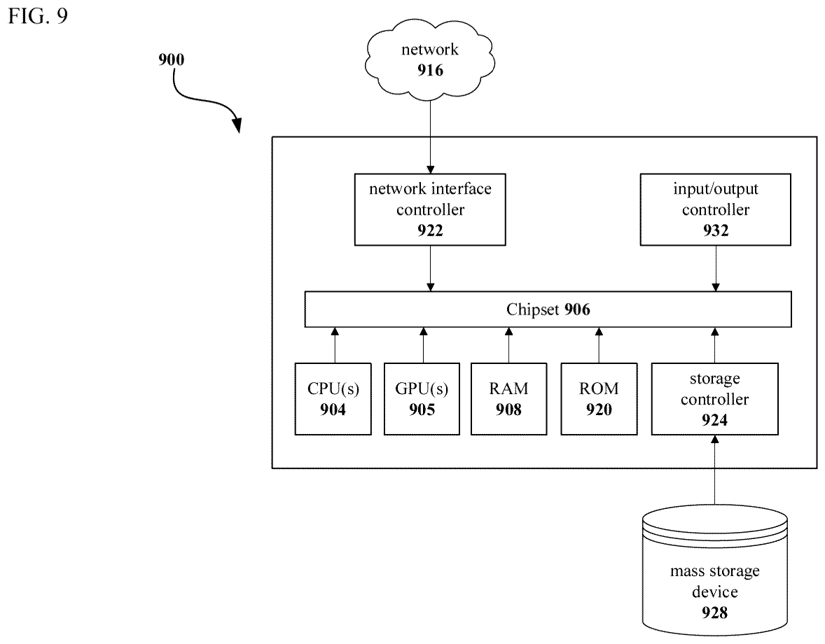

FIG. 9 shows an example computing device 900 that may represent any of the various devices or entities shown in FIG. 1, including, for example, the user device 102, the enterprise cybersecurity system 104, the authentication service 108, the machine learning model 110, the computing devices 112a-112n, or the detection service 114. That is, the computing device 900 shown in FIG. 9 may comprise any smartphone, server computer, workstation, access point, router, gateway, tablet computer, laptop computer, notebook computer, desktop computer, personal computer, network appliance, PDA, e-reader, user equipment (UE), mobile station, fixed or mobile subscriber unit, pager, wireless sensor, consumer electronics, or other computing device, and may be utilized to execute any aspects of the methods and apparatus described herein, such as to implement any of the system of FIG. 1, create the graphs or charts in FIGS. 2-4, or implement any of the methods described in relation to FIGS. 6-8.

The computing device 900 may comprise a baseboard, or “motherboard,” which is a printed circuit board to which a multitude of components or devices may be connected by way of a system bus or other electrical communication paths. One or more central processing units (CPUs or “processors”) 904 may operate in conjunction with a chipset 906. The CPU(s) 904 may be standard programmable processors that perform arithmetic and logical operations necessary for the operation of the computing device 900.

The CPU(s) 904 may perform the necessary operations by transitioning from one discrete physical state to the next through the manipulation of switching elements that differentiate between and change these states. Switching elements may generally comprise electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, or the like.

The CPU(s) 904 may be augmented with or replaced by other processing units, such as GPU(s) 905. The GPU(s) 905 may comprise processing units specialized for but not necessarily limited to highly parallel computations, such as graphics and other visualization-related processing.

A chipset 906 may provide an interface between the CPU(s) 904 and the remainder of the components and devices on the baseboard. The chipset 906 may provide an interface to a random-access memory (RAM) 908 used as the main memory in the computing device 900. The chipset 906 may provide an interface to a computer-readable storage medium, such as a read-only memory (ROM) 920 or non-volatile RAM (NVRAM) (not shown), for storing basic routines that may help to start up the computing device 900 and to transfer information between the various components and devices. ROM 920 or NVRAM may also store other software components necessary for the operation of the computing device 900 in accordance with the aspects described herein.

The computing device 900 may operate in a networked environment using logical connections to remote computing nodes and computer systems of the system 100. The chipset 906 may comprise functionality for providing network connectivity through a network interface controller (NIC) 922. A NIC 922 may be capable of connecting the computing device 900 to other computing nodes over the system 100. It should be appreciated that multiple NICs 922 may be present in the computing device 900, connecting the computing device to other types of networks and remote computer systems. The NIC 922 may be configured to implement a wired local area network technology, such as IEEE 802.3 (“Ethernet”) or the like. The NIC 922 may also comprise any suitable wireless network interface controller capable of wirelessly connecting and communicating with other devices or computing nodes on the system 100. For example, the NIC 922 may operate in accordance with any of a variety of wireless communication protocols, including for example, the IEEE 802.11 (“Wi-Fi”) protocol, the IEEE 802.16 or 802.20 (“WiMAX”) protocols, the IEEE 802.15.4a (“Zigbee”) protocol, the 802.15.3c (“UWB”) protocol, or the like.

The computing device 900 may be connected to a mass storage device 928 that provides non-volatile storage (i.e., memory) for the computer. The mass storage device 928 may store system programs, application programs, other program modules, and data, which have been described in greater detail herein. The mass storage device 928 may be connected to the computing device 900 through a storage controller 924 connected to the chipset 906. The mass storage device 928 may consist of one or more physical storage units. A storage controller 924 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 900 may store data on a mass storage device 928 by transforming the physical state of the physical storage units to reflect the information being stored. The specific transformation of a physical state may depend on various factors and on different implementations of this description. Examples of such factors may comprise, but are not limited to, the technology used to implement the physical storage units and whether the mass storage device 928 is characterized as primary or secondary storage or the like.

For example, the computing device 900 may store information to the mass storage device 928 by issuing instructions through a storage controller 924 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 900 may read information from the mass storage device 928 by detecting the physical states or characteristics of one or more particular locations within the physical storage units.

In addition to the mass storage device 928 described herein, the computing device 900 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 900.

By way of example and not limitation, computer-readable storage media may comprise volatile and non-volatile, non-transitory computer-readable storage media, and removable and non-removable media implemented in any method or technology. However, as used herein, the term computer-readable storage media does not encompass transitory computer-readable storage media, such as signals. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other non-transitory medium that may be used to store the desired information in a non-transitory fashion.

A mass storage device, such as the mass storage device 928 depicted in FIG. 9, may store an operating system utilized to control the operation of the computing device 900. The operating system may comprise a version of the LINUX operating system. The operating system may comprise a version of the WINDOWS SERVER operating system from the MICROSOFT Corporation. According to additional aspects, the operating system may comprise a version of the UNIX operating system. Various mobile phone operating systems, such as IOS and ANDROID, may also be utilized. It should be appreciated that other operating systems may also be utilized. The mass storage device 928 may store other system or application programs and data utilized by the computing device 900.

The mass storage device 928 or other computer-readable storage media may also be encoded with computer-executable instructions, which, when loaded into the computing device 900, transforms the computing device from a general-purpose computing system into a special-purpose computer capable of implementing the aspects described herein. These computer-executable instructions transform the computing device 900 by specifying how the CPU(s) 904 transition between states, as described herein. The computing device 900 may have access to computer-readable storage media storing computer-executable instructions, which, when executed by the computing device 900, may perform the methods described in relation to FIGS. 3-6.

A computing device, such as the computing device 900 depicted in FIG. 9, may also comprise an input/output controller 932 for receiving and processing input from a number of input devices, such as a keyboard, a mouse, a touchpad, a touch screen, an electronic stylus, or other type of input device. Similarly, an input/output controller 932 may provide output to a display, such as a computer monitor, a flat-panel display, a digital projector, a printer, a plotter, or other type of output device. It will be appreciated that the computing device 900 may not comprise all of the components shown in FIG. 9, may comprise other components that are not explicitly shown in FIG. 9, or may utilize an architecture completely different than that shown in FIG. 9.

As described herein, a computing device may be a physical computing device, such as the computing device 900 of FIG. 9. A computing device may also comprise a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is not intended to be limiting.

As used in the specification and the appended claims, the singular forms “a,” “an,” and “the” comprise plural referents unless the context clearly dictates otherwise. Ranges may be expressed herein as from “about” one particular value, and/or to “about” another particular value. When such a range is expressed, another example may comprise from the one particular value and/or to the other particular value. It will be further understood that the endpoints of each of the ranges are significant both in relation to the other endpoint, and independently of the other endpoint.

“Optional” or “optionally” means that the subsequently described event or circumstance may or may not occur, and that the description comprises instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers, or steps. “Exemplary” means “an example of.”. “Such as” is not used in a restrictive sense, but for explanatory purposes.

Components and devices are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any combination of the described methods.

As will be appreciated by one skilled in the art, the methods and systems may take the form of entirely hardware, entirely software, or a combination of software and hardware aspects. Furthermore, the methods and systems may take the form of a computer program product on a computer-readable storage medium having computer-readable instructions (e.g., computer software or program code) embodied in the storage medium. More particularly, the present methods and systems may take the form of web-implemented computer software. Any suitable computer-readable storage medium may be utilized including hard disks, CD-ROMs, optical storage devices, or magnetic storage devices.

The methods and systems are described above with reference to block diagrams and flowcharts of methods, systems, apparatuses, and computer program products. It will be understood that each block of the block diagrams and flowcharts, and combinations of blocks in the block diagrams and flowcharts, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added or removed. The example systems and components described herein may be configured differently than described. For example, elements may be added to, removed from, or rearranged.

It will also be appreciated that various items are shown as being stored in memory or on storage while being used, and that these items or portions thereof may be transferred between memory and other storage devices for purposes of memory management and data integrity. Alternatively, some or all of the software modules and/or systems may execute in memory on another device and communicate with the shown computing systems via inter-computer communication. Furthermore, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms. Accordingly, the present invention may be practiced with other computer system configurations.

While the methods and systems have been described in connection with specific examples, it is not intended that the scope be limited to the specific examples set forth.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including matters of logic with respect to arrangement of steps or operational flow and the plain meaning derived from grammatical organization or punctuation.

It will be apparent to those skilled in the art that various modifications and variations may be made without departing from the scope or spirit of the present disclosure. Alternatives will be apparent to those skilled in the art from consideration of the specification and practices described herein. It is intended that the specification and example figures be considered as exemplary only, with a true scope and spirit being indicated by the following claims.

What is claimed is:

1. A method comprising:
receiving group membership data for a user account of an enterprise, wherein the group membership data indicates at least a plurality of groups of the enterprise associated with the user account;
determining, based on inputting the group membership data into a model, a classification of the user account, wherein the model is trained to classify user accounts according to enterprise-related responsibilities associated with group membership data for the user accounts;
causing, based on the classification of the user account, an adjustment of security data associated with the user account.

2. The method of claim 1, wherein the model is a machine learning model that comprises one or more of a support vector machine, a binary classifier, or a model configured to classify user accounts based on the enterprise-related responsibilities.

3. The method of claim 1, wherein the groups of the enterprise are assigned on an enterprise level using a service configured to manage associations between user accounts and enterprise groups.

4. The method of claim 1, wherein the model is updated based on updates in associations of the groups of the enterprise with corresponding user accounts.

5. The method of claim 1, wherein the adjustment of security data associated with the user account comprises at least one of:
adding an authentication process to the user account; or
monitoring activity of the user account.

6. The method of claim 1, wherein the classification of the user account is based on at least one of:
a quantity of groups of the plurality of groups of the enterprise associated with the user account;
a type of groups of the plurality of groups of the enterprise associated with the user account;
a quantity of permissions associated with the enterprise-related responsibilities of the user account; or
a type of permission associated with the enterprise-related responsibilities of the user account.

7. The method of claim 1, wherein the user account of the enterprise is associated with an employee of the enterprise.

8. A method comprising:
determining training data associated with a plurality of user accounts of an enterprise;
training, based on the training data, a model to classify user accounts according to enterprise-related responsibilities associated with group membership data for the user accounts, wherein the group membership data indicates a plurality of groups of the enterprise associated with the user accounts; and
processing, based on data classified using the model, a plurality of requests to access a service associated with the enterprise, wherein a first portion of the requests associated with a user account having a first classification are associated with a first level of security data and a second portion of the requests associated with another user account having a second classification are associated with a second level of security data.

9. The method of claim 8, wherein the training data comprises, for each user account, an indication of a classification of the user account and an indication of which enterprise groups the user account is associated with.

10. The method of claim 8, wherein the model is a machine learning model that comprises one or more of a support vector machine, a binary classifier, or a model configured to classify user accounts based on the enterprise-related responsibilities.

11. The method of claim 8, wherein the enterprise groups are assigned on an enterprise level using a service configured to manage associations between user accounts and enterprise groups.

12. The method of claim 8, further comprising updating associations of enterprise groups with corresponding user accounts and retraining the model based on the updated associations.

13. The method of claim 8, wherein the first level of security data comprises requesting a first credential of the user account, and wherein the second level of security data comprises requesting the first credential and a second credential of the user account.

14. The method of claim 8, wherein the classifying the user accounts is based on at least one of:
a quantity of groups of the plurality of groups of the enterprise associated with that user account;
a type of groups of the plurality of groups of the enterprise associated with that user account;
a quantity of permissions associated with the enterprise-related responsibilities of that user account; or
a type of permission associated with the enterprise-related responsibilities of that user account.

15. The method of claim 8, wherein the plurality of user accounts of the enterprise is associated with a plurality of employees of the enterprise.

16. A method comprising:
receiving group membership data for a user account of an enterprise, wherein the group membership data indicates at least a plurality of groups of the enterprise associated with the user account;
determining, based on inputting the group membership data for the user account into a model, a classification of that user account, wherein the model is trained to classify user accounts according to enterprise-related responsibilities associated with the group membership data of the user accounts;
detecting an event associated with user activity of the user account; and
processing, based on the classification of the user account being associated with more enterprise-related responsibilities than a different classification, the event.

17. The method of claim 16, wherein processing the event comprises one or more of:
increasing the security data associated with the user account;
filtering the event for a security service;
generating an indication of potential threat for the security service;
sending an alert to the security service; or
ignoring the event.

18. The method of claim 16, wherein the model is a machine learning model that comprises one or more of a support vector machine, a binary classifier, or a model configured to classify user accounts based on the enterprise-related responsibilities.

19. The method of claim 16, wherein the enterprise groups are assigned on an enterprise level using a service configured to manage associations between user accounts and enterprise groups.

20. The method of claim 16, wherein the classification of the user account is based on at least one of:
a quantity of groups of the plurality of groups of the enterprise associated with that user account;
a type of groups of the plurality of groups of the enterprise associated with that user account;
a quantity of permissions associated with the enterprise-related responsibilities of the user account; or
a type of permission associated with the enterprise-related responsibilities of the user account.
